(19) United States
(12) Patent Application Publication
(10) Pub. No.: US 2015/0286687 A1
(43) Pub. Date: Oct. 8, 2015

(54) INFORMATION PROCESSING APPARATUS, INFORMATION PROCESSING METHOD, AND RECORDING MEDIUM

(71) Applicant: CANON KABUSHIKI KAISHA, Tokyo (JP)

(72) Inventor: Koichi Kuno, Tokyo (JP)

(21) Appl. No.: 14/676,677

(22) Filed: Apr. 1, 2015

(30) Foreign Application Priority Data
Apr. 7, 2014 (JP) 2014-078559

(51) Int. Cl. G06F 17/30

(52) U.S. Cl. CPC G06F 17/30551; G06F 17/3053; G06F 17/3087

(57) ABSTRACT

A place name search apparatus that searches a place name database for a place name, which includes place name data that defines place name information representing a place name, effective period information representing a period during which the place name is effective, and region information representing a region covered by the place name, includes an acquisition unit that acquires position information and date/time information and a search unit that searches the place name database for place name data including region information including the acquired position information and effective period information corresponding to the acquired date/time information.

### BACKGROUND

1. Field

Aspects of the present invention generally relate to an information processing apparatus that searches for a place name or searches for data corresponding to the place name, an information processing method, and a recording medium.

2. Description of the Related Art

Conventionally, there has been a technique for specifying a place name by utilizing position information (latitude/longitude coordinate values) obtained by a Global Positioning System (GPS). In this case, when the position information and the place name are in a one-to-one relationship, if the place name is changed, for example, a place name identified corresponding to the position information is also desirably changed. Japanese Patent Application Laid-Open No. 2009-14630 discusses a technique for displaying, for a place name that is scheduled to be changed in the future, a new place name thereof after the change.

If a user desires to search for a place name before change, for example, if the place name is replaced with a new place name, as discussed in Japanese Patent Application Laid-Open No. 2009-14630, the place name before the change may not be able to be found.

### SUMMARY

Aspects of the present invention are generally directed to an information processing apparatus, an information processing method, and a recording medium capable of searching for appropriate place name information corresponding to a date/time specified by an instruction from a user or appropriate data corresponding to a place name designated by the user even if a place name has been changed.

According to an aspect of the present invention, an information processing apparatus configured to search a place name database for a place name, the place name database including place name data that defines place name information representing a place name, effective period information representing a period during which the place name is effective, and region information representing a region covered by the place name includes an acquisition unit configured to acquire position information and date/time information, and a search unit configured to search the place name database for at least one piece of place name data including region information including the position information acquired by the acquisition unit and effective period information corresponding to the date/time information acquired by the acquisition unit.

Further features of the present disclosure will become apparent from the following description of exemplary embodiments with reference to the attached drawings.

### BRIEF DESCRIPTION OF THE DRAWINGS

FIG. 1 is a block diagram illustrating a schematic configuration of a personal computer (PC) according to a first exemplary embodiment.

FIG. 2 is a block diagram illustrating a schematic configuration of a network including the PC.

FIG. 3 illustrates a place name database and place name data.

FIG. 4 illustrates the place name database and a place name data group.

FIG. 5 is a flowchart for searching for a place name based on position information.

FIG. 6 (consisting of 6A and 6B) is a flowchart illustrating an operation for searching for position information based on a place name.

FIG. 7 illustrates region information.

FIG. 8 is a flowchart illustrating a flow for checking whether the position information is included in the region information.

FIG. 9 illustrates an inclusive relationship of regions.

FIG. 10 illustrates an application for displaying a place name.

FIG. 11 illustrates an application for searching for an image by a place name.

### DESCRIPTION OF THE EMBODIMENTS

Exemplary embodiments will be described in detail below with reference to the attached drawings.

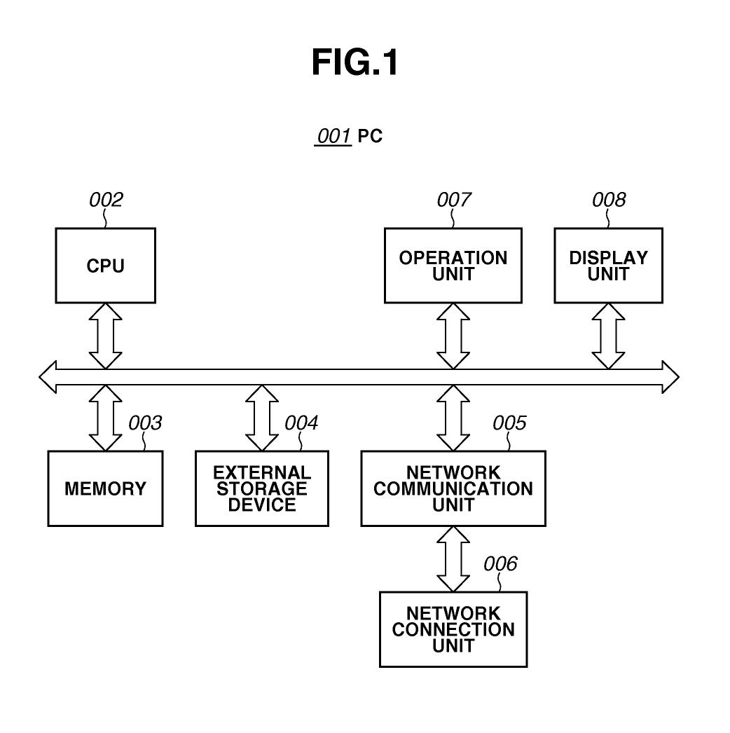

FIG. 1 is a block diagram illustrating a schematic configuration of a personal computer (PC) 001 according to a first exemplary embodiment.

A central processing unit (CPU) 002 controls each unit in the PC 001. The CPU 002 temporarily stores data in a memory 003, as needed, and performs buffering. An external storage device 004 is a disk device that stores an application program read out by the CPU 002 and an operating system (OS), and stores various types of files. A network communication unit 005 connects the PC 001 to a network, to perform various types of communication. A network connection unit 006 is a connection unit for connecting the network communication unit 005 to a network medium. The network communication unit 005 and the network connection unit 006 support at least one of a wired local area network (LAN) and a wireless LAN. More specifically, each of the network communication unit 005 and the network connection unit 006 has a required function and form according to the corresponding LAN.

An operation unit 007 includes a keyboard and a mouse, and a display unit 008 includes a liquid crystal display (LCD).

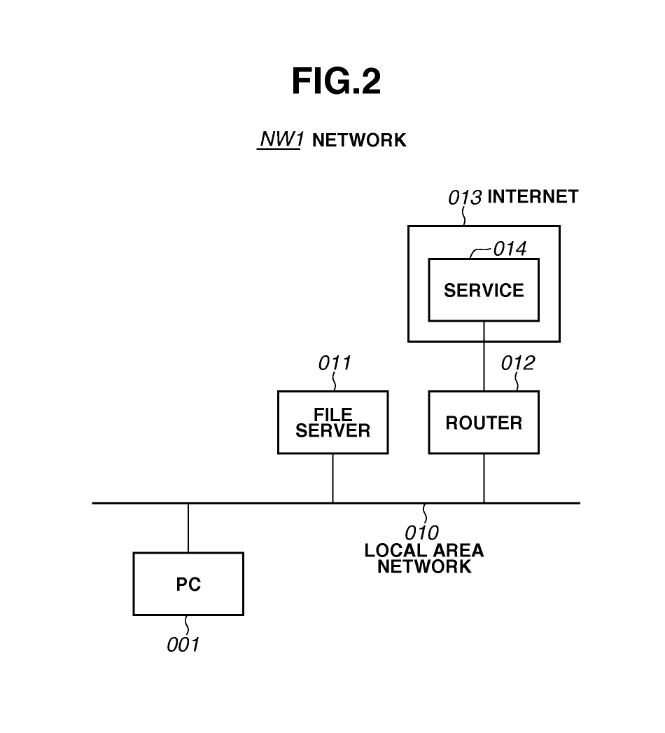

FIG. 2 is a block diagram illustrating a schematic configuration of a network NW1 including the PC 001.

The PC 001 is connected to a local area network 010, and can access information placed outside the PC 001. Data is stored in a file server 011 connected to the local area network 010 in addition to the external storage device 004. If the PC 001 is connected to the Internet 013 via a router 012, the data may be provided from a service 014 on the Internet 013.

A place name database 100 to be a base for the first exemplary embodiment will be described below.

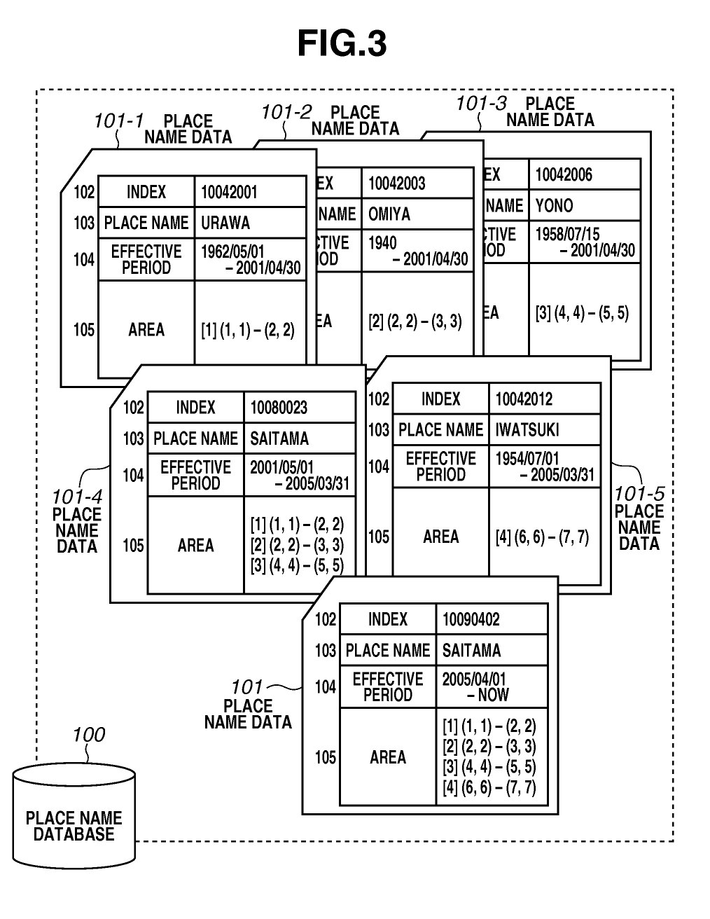

FIG. 3 illustrates the place name database 100 and place name data 101.

The place name database 100 includes a plurality of place name data 101, and is a searchable database. The place name database 100 may be stored in the file server 011 connected to the local area network 010 in addition to the external storage device 004. If the PC 001 is connected to the Internet 013 via the router 012, data may be provided from the service 014 on the Internet 013. If the data is provided from the service 014, incorporation of information about the place name data 101 may be optimized according to the service.

If the place name database 100 is stored in the external storage device 004, a user of the PC 001 can update contents of the place name database 100, as needed. If the place name database 100 is stored in each of the file server 011 and the service 014, each manager thereof can update the contents of the place name database 100, as needed.

As illustrated in FIG. 3, each of the place name data 101, 101-1, 101-2, 101-3, 101-4, and 101-5 includes an index 102, place name information 103, effective period information 104, and region information 105.

The index 102 is a management number on the place name database 100, for which a unique value is defined so that the same value is not defined among different place name data and with which one of the place name data 101 can be uniquely extracted.

The place name information 103 is defined by a character string. At least one place name is defined as the place name information 103. In the present exemplary embodiment, the place name database 100 can be searched for place name data corresponding to a place name input in characters by the user, for example. However, the same place name may have a plurality of nominal designations and a plurality of description forms, or there may be a minimal error in the characters input by the user. If the same place name “TORANOMON” is written as “TORA-NO-MON”, “TORANO-MON”, and “Tranomon” in different expressions, for example, a plurality of place names may be listed by being separated with break characters. The place names are separated with the break characters, are extracted, and are processed when listed. If any one of the plurality of place names matches the place name input in characters by the user, the place name data 101 representing the place name is processed as matching a search condition. On the other hand, when the place name represented by the place name data 101 is displayed, all candidates to a plurality of place names may be displayed, or the place name at the head of the plurality of place names may be displayed as a representative of the plurality of candidates. Alternatively, to search for the plurality of place names at high speed, an index list serving as a list in which each of the place names separated with the break characters in the place name information 103 is associated with the index 102, to index the place names and arrange the place names in the order of character strings may be separately generated.

The effective period information 104 is information in which a start date/time on which a corresponding place name has been defined and an end date/time on which the place name has been changed are defined.

In the present exemplary embodiment, to search for a place name corresponding to a specific date/time, the place name is searched for using the effective period information 104. If the user designates a date/time, for example, a place name corresponding to the date/time designated by the user can be searched for by searching for the place name data 101 corresponding to the effective period information 104 including the date/time.

If a start date/time is unclear, “unclear” is displayed, and the start date/time is excluded from a target of date/time determination. If a place name has been changed, for example, an end date/time of a past place name may be unclear. In this case, a date/time at a time point where the place name data representing the past place name has been generated may be automatically defined as a temporary end date/time. However, in this case, an actual end date/time of the past place name may differ from the temporary end date/time. When the place name is searched for based on the date/time designated by the user, the past place name, which is not supposed to originally correspond to the date/time, may be found. Therefore, a newest flag is set for the place name data for which the temporary end date/time has been defined. The place name for which the temporary end date/time has been defined as an end date/time can be excluded from a target of date/time determination by setting the newest flag. Similar processing is performed even when not only the end data but also a temporary state date/time is defined.

Furthermore, if the manager of the place name database 100 has defined an end date/time for the place name data 101, for example, the place name data 101 may be a target of date/time determination by releasing the above-mentioned newest flag using the end date/time as a primary end date/time.

If an effective date/time other than the above-mentioned date/times is defined, it is determined that the effective date/time matches a search condition if the date/time designated by the user is after a start date on which the place name corresponding to the designated date/time has been used and before an end date.

The region information 105 is information representing a region covered by a place name. In the present exemplary embodiment, a place name corresponding to specific position information can be searched for by comparing the specific position information with the region information 105.

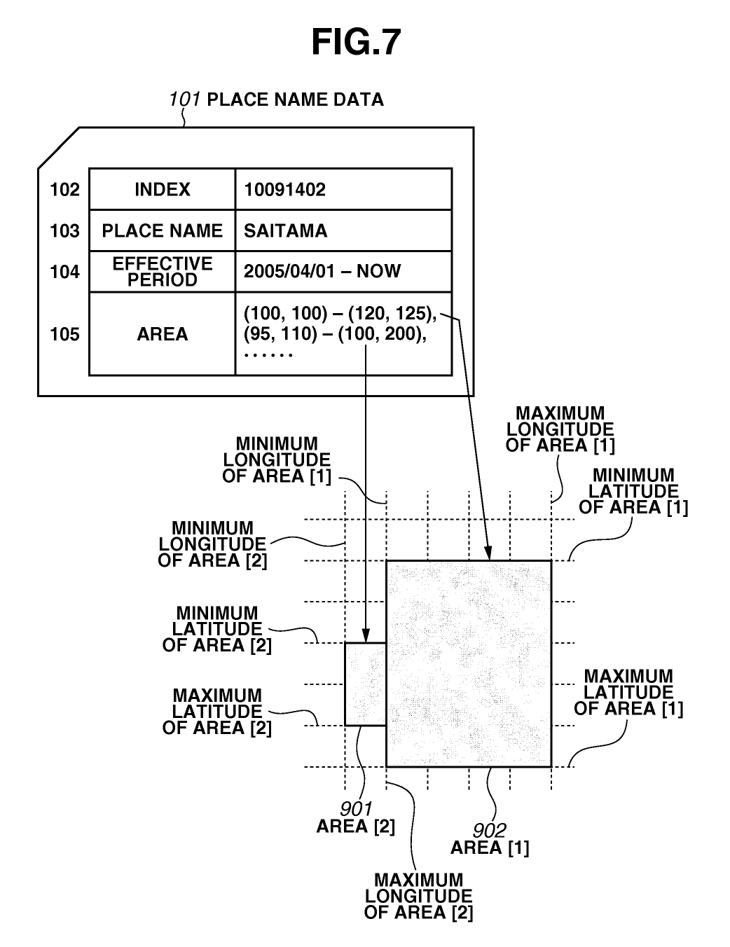

FIG. 7 illustrates the region information 105.

The region information 105 in the place name data 101 is constructed by one or a plurality of rectangles. In an example illustrated in FIG. 7, the region information 105 includes large and small rectangles, for example. An actual region on a map may not be a rectangle. However, a rectangle including the actual region is defined in the region information 105 in the present exemplary embodiment to suppress a data capacity of the region information 105. However, if the rectangle includes only one rectangle, an error between the rectangle and the actual region may become large. Thus, a plurality of rectangles is combined to define the region.

One rectangle includes four values, i.e., a minimum latitude, a minimum longitude, a maximum latitude, and a maximum longitude, and has a width from the minimum longitude to the maximum longitude and has a height from the minimum latitude to the maximum latitude. The minimum size of the rectangle is a point. The minimum longitude and the maximum longitude of this point have the same value, and the minimum latitude and the maximum latitude thereof have the same value.

It is determined at high speed whether the region information 105 is effective in the following manner. Specifically, a minimum latitude, a minimum longitude, a maximum latitude, and a maximum longitude among latitudes and longitudes in a plurality of regions are previously found, and are separately defined. A position designated by the user is compared with a region surrounded by the minimum longitude, the minimum longitude, the maximum latitude, and the maximum longitude in the plurality of regions, to search for the position. The position designated by the user is specifically compared with the region information 105 only when it is included in the minimum latitude, the minimum longitude, the maximum latitude, and the maximum longitude in the plurality of regions. Thus, it can be roughly determined whether the position designated by the user is included in the region information 105. Therefore, it can be determined at high speed whether the region information 105 is effective.

The region information 105 may be defined as a polygon connecting a plurality of points constituting each of a plurality of regions instead of being defined by a group of rectangles. If the region information 105 matches a search condition, a polygon with a bit set to 1 may be drawn and represented by binary image data in which corresponding portions are filled and a coordinate value of an offset position at the head of the image data. Even if the region information 105 does not have the same data structure as a definition of the place name data 101, the region information 105 may be used in combination with existing corresponding information. For example, any region information such as a vector format may be used.

Then, in the present exemplary embodiment, an operation for searching for a newest place name, based on the position information such as a latitude and a longitude which image data (e.g., digital camera picture) has, corresponding to the position information, will be described below.

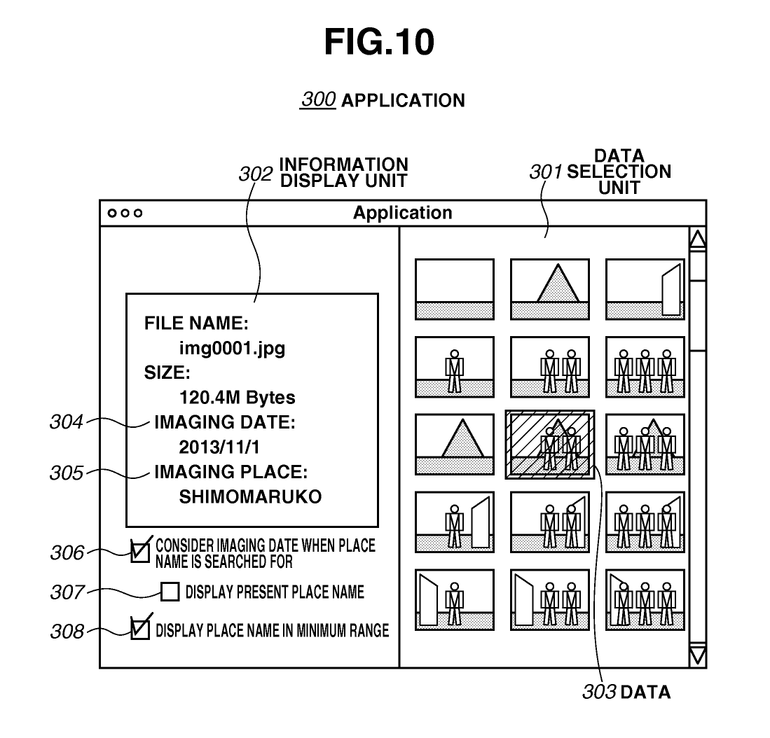

FIG. 10 illustrates an application 300 for displaying a place name.

The application 300 includes a data selection portion 301 that designates an image file serving as a target to be displayed and an information display portion 302 that displays information about the selected image file.

The application 300 may be not only an application program on a computer but also a service on a network called and controlled from a browser.

When data 303 selected by the user is selected in the data selection portion 301, the application 300 extracts position information 305 (tag information in an Exchangeable Image File Format (EXIF)) of an imaging place embedded in the data 303. The extracted position information 305 is converted into a latitude/longitude. If the position information 305 exists, the place name database 100 is searched based on coordinates (latitude/longitude), to obtain an index list including the found place name data 101 (i.e., the place name information 103 is effective in the found place name data).

When “consider imaging date when place name is searched for” 306 is checked in the information display portion 302, the application 300 extracts imaging date information 304 embedded in the data 303. The imaging data information 304 is also stored in an image file as tag information in the EXIF file. It is determined whether the effective period 104 in the place name data 101 in the index list previously found based on the coordinates includes the imaging date information 304. If the imaging date information 304 is not included in the effective period 104, i.e., is not within an effective period, the place name data 101 is excluded from the list.

When “display present place name” 307 is checked in the information display portion 302, the search is performed by not extracting an imaging date from the data 303 but using a present date/time.

When “display place name in minimum range” 308 is checked in the information display portion 302, the application 300 compares the areas of the place name data 101 searched for based on the coordinates in the index list, selects the place name data 101 having the minimum area, and displays a place name represented by the place name data 101. If “display place name in minimum range” 308 is not checked in the information display portion 302, the place name data 101 searched for based on the coordinates in the index list are stored by area, and the sorted (hit) place name data 101 are displayed in descending order of their areas. For example, “Japan”, “Tokyo-to”, “Ota-ku”, and “Shimomaruko” are displayed in this order.

When user checks or unchecks “consider imaging date when place name is searched for” 306, it may be displayed to the user on a dialog that data representing a place name change or a region change is narrowed down based on an imaging date. When the user checks or unchecks “display place name in minimum range” 308, it may also be displayed to the user that when a place name in a minimum range is displayed, a place name in a minimum unit among a city, a town, and a village is displayed.

Then, in the above-mentioned exemplary embodiment, an operation for converting position information of data into a place name and displaying the place name will be specifically described.

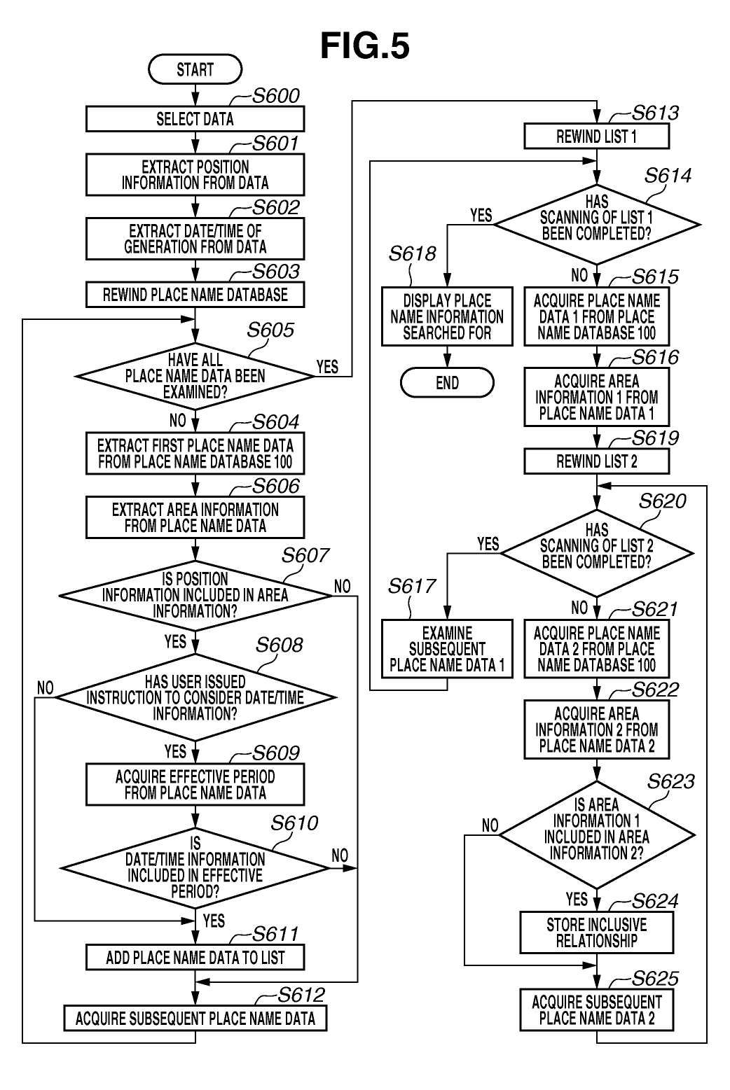

FIG. 5 is a flowchart illustrating an operation for searching for a place name based on position information. The flowchart illustrated in FIG. 5 is implemented in a server that provides the PC 001 or the service 014. An example in which processing is performed in the PC 001 will be described. More specifically, a program corresponding to processing in the flowchart illustrated in FIG. 5 is stored in an auxiliary storage device (not illustrated) in the PC 001. A CPU 002 executes the program on the memory 003, to implement the processing in the flowchart illustrated in FIG. 5.

In the present exemplary embodiment, processing for converting position information (all latitude and longitude information) of data into a place name and displaying the place name will be described with reference to a flowchart implemented by performing a program on the PC 001 or on the service 014 on the Internet 013.

In step S600, the CPU 002 selects target data in response to an instruction to the operation unit 007 by the user. In step S601, the CPU 002 extracts position information from the target data selected by the user. In step S602, the CPU 002 extracts a generation date/time. More specifically, the CPU 002 refers to tag information of an image file in an EXIF format corresponding to the target data. In step S603, the CPU 002 rewinds (initializes) an access point of the place name database 100 to 0 to see all place name data 101 in a place name database 100. In step S605, the CPU 002 determines whether all the place name data 101 have been examined. If it is determined that all the place name data 101 have not been examined (NO in step S605), then in step S604, the CPU extracts the first place name data 101 from the place name database 100.

In step S606, the CPU 002 extracts region information 105 from the place name data 101. In step S607, the CPU 002 determines whether the position information, which has been extracted in step S601, is included in the region information 105. If the position information is not included in the region information 105 (NO in step S607), then in step S612, the CPU 002 acquires the subsequent place name data 101. If it is determined that the acquired place name data 101 is not final data (NO in step S605), the determination processing in step S604 and the subsequent steps is repeated.

In step S607, the CPU 002 determines whether the position information, which has been extracted in step S601, is included in the place name data 101. If it is determined that the position information is included in the place name data 101 (YES in step S607), then in step S608, the CPU 002 examines whether the user has issued an instruction to “consider date/time information”. If the user has issued the instruction to “consider date/time information” (YES in step S608), then in step S609, the CPU 002 acquires an effective period 104 of a place name from the place name data 101. In step S610, the CPU 002 determines whether date/time information of the target data, which has been selected in step S600, is included in the effective period 104. If the date/time information is included in the effective period 104 (YES in step S610), then in step S611, the CPU 002 adds the place name data 101 including the effective period 104 to a list as matching a search condition.

If the user selects an image or issues an instruction to search for a place name considering date/time information, for example, by processes in steps S600 to S612, described above, a list including a place name corresponding to a date/time on which and a location in which the image has been captured is generated. If the image is an image captured before the present place name is changed or an image captured in a location serving as a place name different from the present place name, for example, a list including the place name at the time when the image was captured is generated.

In the above-mentioned list, an inclusive relationship of regions has not been considered. More specifically, if “Tokyo” and “Japan”, for example, are searched for as place names, their inclusive relationship has not been specified. The inclusive relationship of the regions in the list is specified by processes in steps S613 to S625.

If it is determined that all the place name data 101 have been examined (YES in step S605), then in step S613, the CPU 002 rewinds the list generated during the examination to sequentially examine the list, and the CPU 002 examines the subsequent place name data 101.

In step S615, the CPU 002 acquires place name data 101 included in the list from the place name database 100. In step S616, the CPU 002 acquires region information 105 from the place name data 101. To compare the acquired region information 105 with region information 105 in the other place name data 101 in the list, the CPU 002 repeatedly performs processes in steps S619 to S622 for the other place name data 101 in the list. In step S623, the CPU 002 compares the region information 105, and determines whether the region information 105 in the place name data 101 (1) is included in the region information 105 in the other place name data 101 (2). If the region information 105 in the place name data 1 is included in the region information 105 in the place name data 2 (YES in step S623), then in step S624, the CPU 002 stores their inclusive relationship. In step S614, the CPU 002 determines whether scanning of the list has been entirely completed. If the scanning of the list has been completed (YES in step S614), an inclusive relationship of all the place name data 101 becomes clear.

A list including the place name data 101 of which the inclusive relationship has become clear is generated. In step S618, the CPU 002 displays the place name information 103 in the place name data 101 matching a search condition as the place name. If there is a plurality of place name data 101, the CPU 002 may hierarchically output the place name data 101 by sequentially displaying regions in the place name data 101 in descending order of their areas in the inclusive relationship. Alternatively, the CPU 002 may display only the minimum region included by the plurality of regions as the place name.

In the present exemplary embodiment, the process in step S607 illustrated in FIG. 5, i.e., processing for determining whether a position corresponding to an image is included in a region represented by region information 105 in the place name data 101 will be described below.

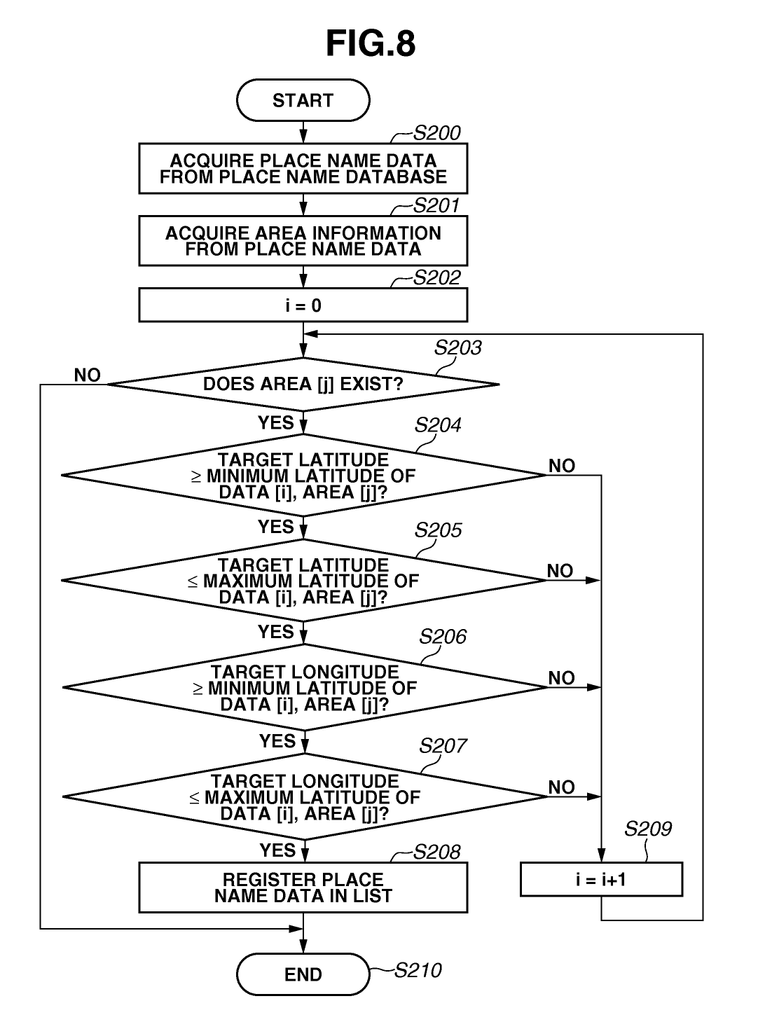

FIG. 8 is a flowchart for examining whether a target position (a position designated by the user) is included in the region information 105. More specifically, FIG. 8 is a diagram illustrating a method for searching for coordinates in the present exemplary embodiment and a flowchart illustrating an operation of a program operating on the PC 001 or on the service 014 on the Internet 013.

In steps S200 and S201, the CPU 002 acquires region information 105 from the place name data 101. In step S202, 203, and 209, the CPU 002 performs loop control to sequentially see a rectangle defining a region. In step S204, the CPU 002 determines whether a target latitude (a latitude in position information 103 designated by the user) is equal to or more than a minimum latitude of the region. In step S205, the CPU 002 determines whether a maximum latitude (a maximum latitude at a target position) is equal to or less than a maximum latitude of the region. In step S206, the CPU 002 determines whether a target longitude (a longitude in the position information 103 designated by the user) is equal to or more than a minimum longitude of the region. In step S207, the CPU 002 determines whether the target longitude is equal to or less than a maximum longitude of the region. If all steps S204, S205, S206, and S207 are satisfied (YES in steps S204, S205, S206, and S207), then in step S208, the CPU 002 registers an index 102 in the place name data 101 in a list as matching a search condition.

In step S623 illustrated in FIG. 5, processing for determining whether the place name data 1 is included in the place name data 2 will be described below.

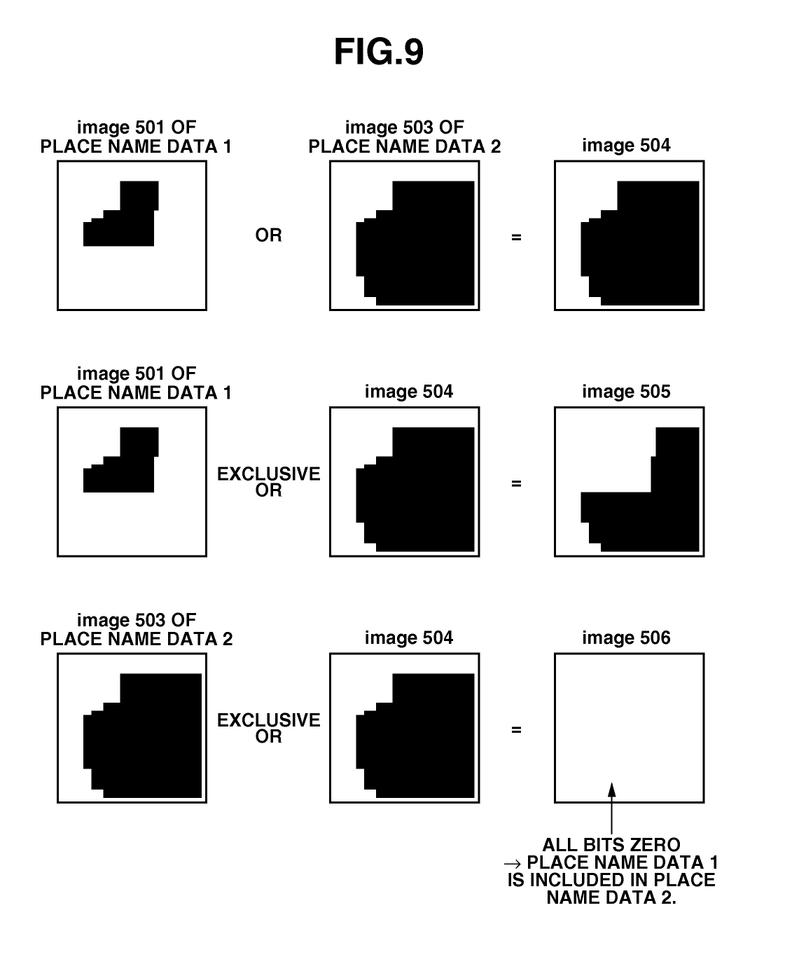

FIG. 9 illustrates a method for finding an inclusive relationship of regions. Ranges of regions are respectively represented by bit images, and the inclusive relationship of the regions is determined by checking overlapping of the regions. First, region information 105 is rasterized into a binary map image having a value of “1” or “0”. A size to be generated is a maximum size starting with a minimum offset of the sum of an image 501 of the place name data 1 and an image 503 of the place name data 2, and one pixel is a minimum unit. In coordinates of the image 501 of the place name data 1, bits corresponding to the region are set to 1 and the other bits are set to 0.

Similarly, in coordinates of the image 503 of the place name data 2, bits corresponding to the region are set to 1 and the other bits are set to 0. An image 504 is the logical OR of the image 501 of the place name data 1 and the image 503 of the place name data 2. The exclusive OR (XOR) of each of the image 501 of the place name data 1 and the image 503 of the place name data 2 and the image 504 is obtained. In a region obtained by the XOR, bits corresponding to either one of the two regions to be compared are 1.

In the present exemplary embodiment, the logical OR of two images to be compared is obtained. The XOR of a result of the OR and each of the two images to be compared is obtained. The logical OR of the two images to be compared can be obtained by determining whether all bits are 0 in a result of the XOR.

If the image 501 is included in the image 503, for example, the image 504, which is the logical OR of the images 501 and 503, is equivalent to the image 503. Therefore, in an image 506 obtained by the XOR of the image 503 and the image 504, all bits are 0. In an image 505 obtained by the XOR of the image 501 and the image 504, all bits are not 0.

The XOR of the image 501 of the place name data 1 and the image 504 of the place name data 2 is the image 505. In the image 505, all bits are not 0. Thus, it is not determined that the image 501 includes the image 504.

On the other hand, a result of the XOR of the image 503 and the image 504 is an image 506. In the image 506, all bits are 0. Thus, it can be determined that the image 503 includes the image 504.

If all bits are 0 in both the two determination results, the image 501 of the place name data 1 and the image 503 of the place name data 2 can have the same region.

Even if only a part of the two images to be compared overlaps each other, for example, all bits are not 0 in a result of the XOR of the images according to the above-mentioned determination. Therefore, in this case, it can also be determined that the two images are not in an inclusive relationship.

Overlapping portions can be different regions because a partial region is merged into the other city due to a municipal merger. In this case, if a position corresponding to an image, for example, is the above-mentioned partial region, two place names before and after the merger can be extracted as data having no inclusive relationship.

If the inclusive relationship is rapidly examined, it is roughly determined whether the regions may be in the inclusive relationship in the following manner. More specifically, a minimum latitude, a minimum longitude, a maximum latitude, and a maximum longitude of whole region information 105 are obtained. The whole region information 105 is compared with each other for the place name data 101. A region corresponding to the place name data 101 may be specifically confirmed as a candidate only if included in a region corresponding to the other place name data 101. On the other hand, a large unit may have region information 105 including all small units. It may be determined whether the region is included in the other region using only the region information 105 in the place name data 101 if the determination can be made only by the coordinates.

An application 300A for searching for an image based on a place name will be described below.

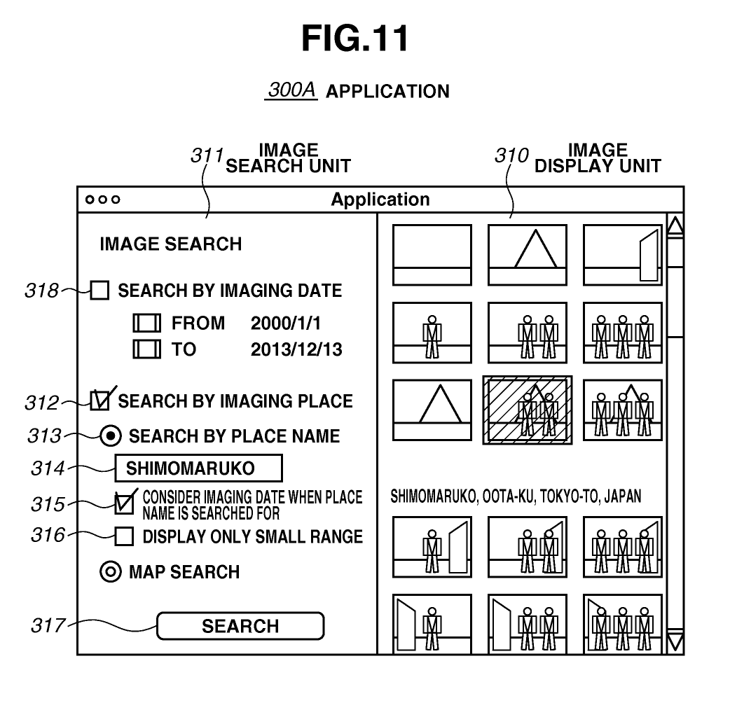

FIG. 11 illustrates the application 300A for searching for an image based on a place name.

The application 300A includes an image search unit 311 that designates an image search method, and an image display unit 310 that displays the found image. The application 300A may be not only an application program on a computer but also a service on a network called and controlled from a browser.

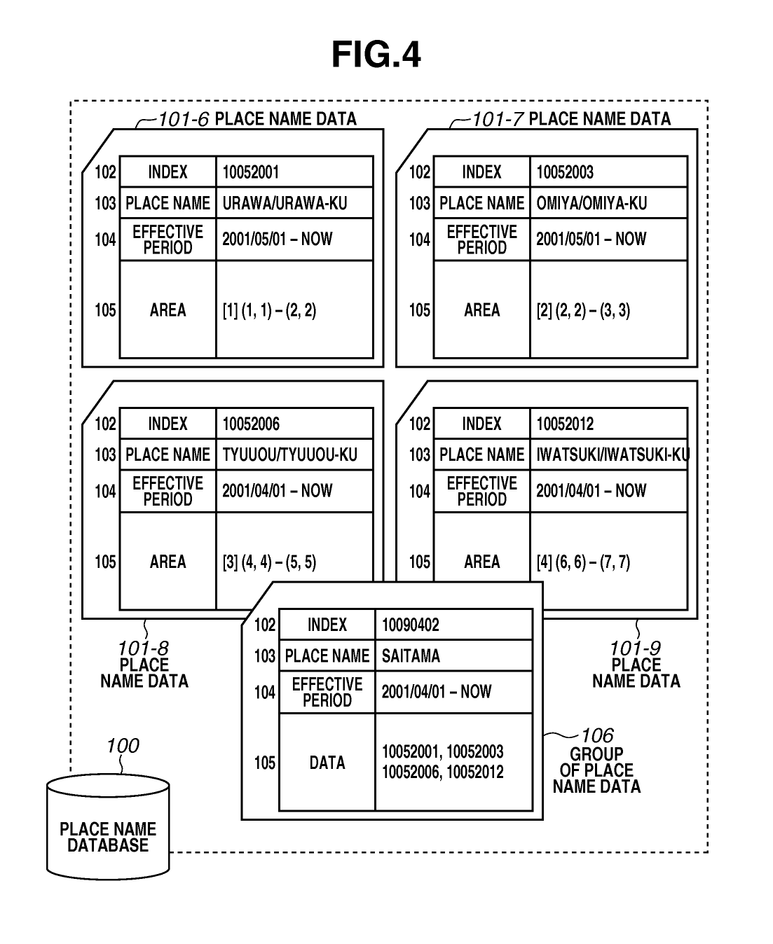

If the image is searched for based on a place name, a “search by imaging place” check box 312 is checked, and is validated, a “search by place name” radio button 313 is selected, and a place name is input to a place name input column 314. When a “search” button 317 is clicked, the search is started. When the image is searched for based on the place name, a search result is as described in the place name information 103 illustrated in FIGS. 3 and 4.

When a “consider imaging date when place name is searched for” check box 315 is checked, the application 300A extracts information about an imaging date embedded in the place name data 101. It is determined whether an imaging date/time is included in effective period information 104 in the place name data 101 in a list of indexes 102 previously found based on coordinates. If the imaging date/time is not included, the index 102 in the place name data 101 is excluded from the list.

When a plurality of place name data 101 has been detected, region information 105 in each of the place name data 101 and position information of data (an imaging place) are compared with each other. If the region information 105 and the position information correspond to each other, a place name is registered in a list including each of the place name data 101.

As a method for narrowing down the list including the plurality of place name data 101, if coordinate information of place name data A includes coordinate information of place name data B, an operation differs depending on whether a “display only small range” check box 316 has been checked. If the “display only small range” check box 316 has been checked, the place name data A is excluded from a target, and only the place name data B is extracted. On the other hand, if the “display only small range” check box 316 has not been checked, the place name data A is extracted.

If all data are set to be specifically displayed, the data may be simultaneously displayed by separating contents of the place name data A and the place name data B. For data existing in both the place name data A and B, the place name data A may not be displayed and only the place name data B may be displayed.

When the user checks or unchecks the “consider imaging date when place name is searched for” check box 315, it may be displayed to the user on a dialog that data representing a place name change or a region change is narrowed down depending on an imaging date. When the user checks or unchecks the “display only small range” check box 316, it may also be displayed to the user that when only “display only small range” is set, only corresponding data in a minimum unit among a city, a town, and a village having the same name is displayed.

In a second exemplary embodiment, a user designates a place name, and searches for data corresponding to the designated place name based on position information and date/time information.

A method for searching, if a plurality of position information is included in data, like in the first exemplary embodiment, for the data by a place name and displaying the data searched for will be described.

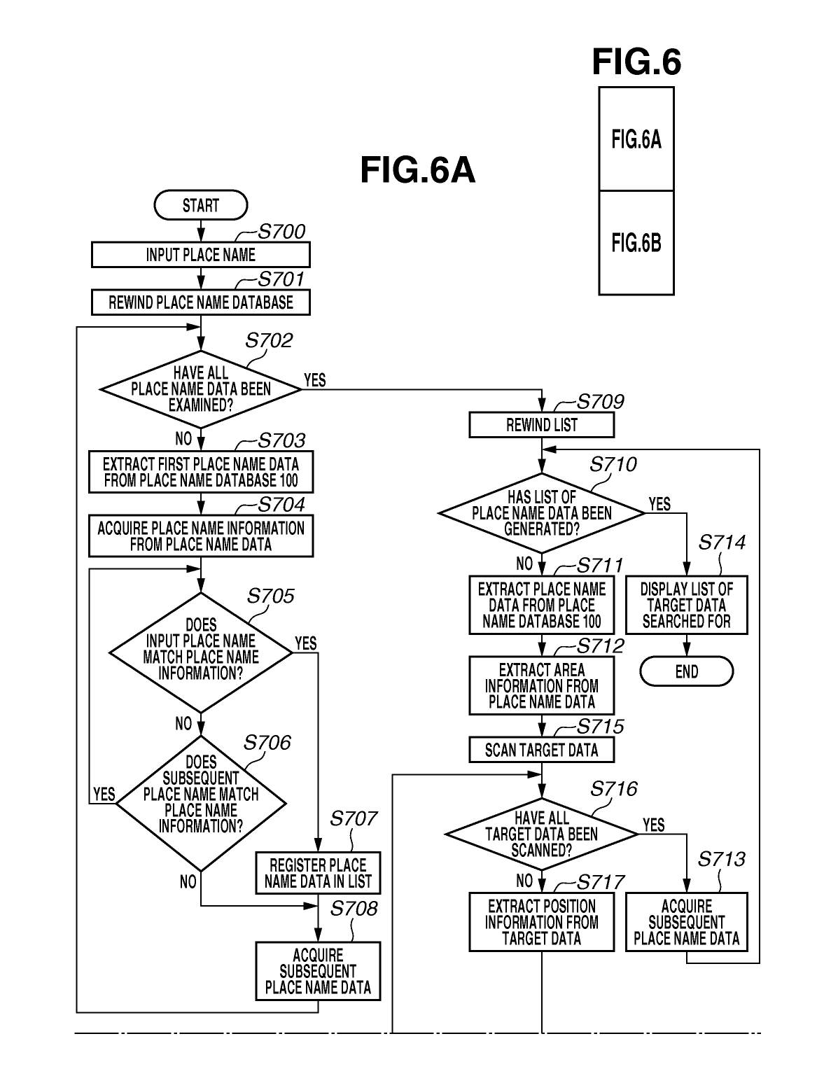

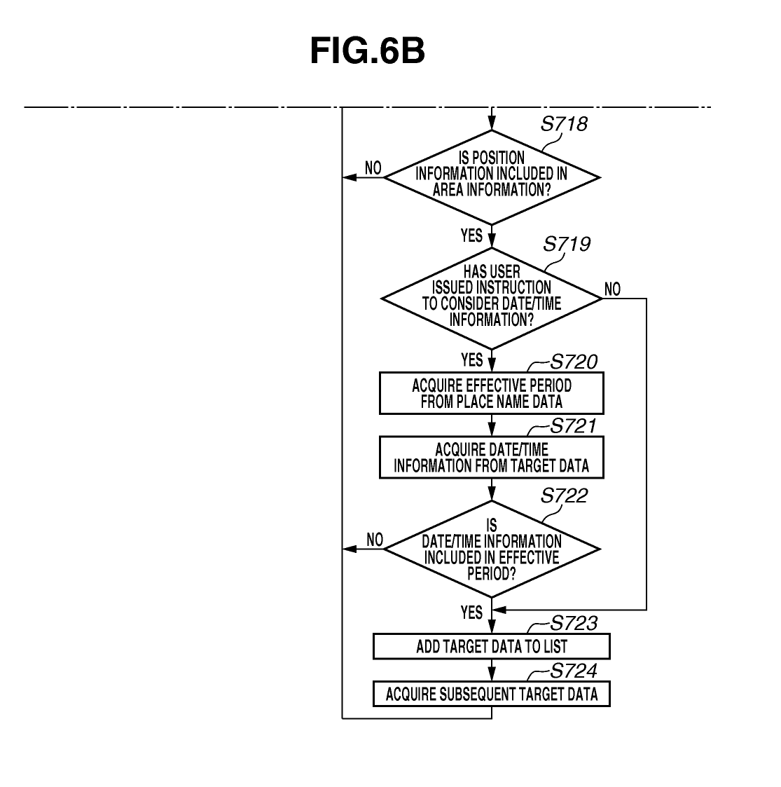

FIG. 6 is a flowchart illustrating an operation for searching for position information based on a place name. The flowchart illustrated in FIG. 6 is implemented in a PC 001 or a server providing a service 014. An example in which processing is performed in the PC 001 will be described. A program corresponding to the processing in the flowchart illustrated in FIG. 6 is stored in an auxiliary storage device (not illustrated) in the PC 001. A CPU 002 executes the program on a memory 003 so that the processing in the flowchart illustrated in FIG. 6 is implemented.

In step S700, the CPU 002 inputs a place name in response to an instruction from the user. The CPU 002 searches for place name data 101 including the place name first input by the user from among all place name data 101, and lists the place name data 101 matching a search condition. In step S701, the CPU 002 rewinds a place name database 100. In step S702, the CPU 002 determines whether all the place name data 101 have been examined. If all the place name data 101 have not been examined (NO in step S702), then in step S703, the CPU 002 acquires the first place name data 101 from the place name database 100. In step S704, the CPU 002 acquires place name information 103 from the place name data 101. The CPU 002 can define a plurality of place names by separating the place name information 103 with break characters.

Accordingly, in step S705, the CPU 002 determines whether the place name input by the user matches the place name information 103. If the place name does not match the place name information 103 (NO in step S705), then in step S706, the CPU 002 extracts a subsequent candidate to the place name information 103, and repeats the determination. If the place name matches the place name information 103 (YES in step S705), then in step S707, the CPU 002 registers the place name data 101 representing the place name that matches the place name information 103 in a list. In step S708, the CPU 002 repeats the same processing for the subsequent place name data 101. The CPU 002 performs scanning for all the place name information 103. If the place name does not match the place name information 103 (NO in step S705), the CPU 002 repeats the same processing for the subsequent place name data 101.

By processes performed in steps S700 to S708, described above, the place name data 101 corresponding to the place names input by the user in the place name database 100 are listed.

When scanning ends for all the place name data 101, a list including the place name data 101 corresponding to the place name input by the user is generated. If there is a plurality of place name data 101, the CPU 002 performs repetitive processing corresponding to the number of the place name data 101 to list data corresponding to all the place name data 101 in processes performed in step S709 and the subsequent steps. In step S711, the CPU 002 first extracts the place name data 101 included in the list generated by the process performed in step S707 from the place name database 100. In step S712, the CPU 002 extracts the region information 105 from the acquired place name data 101. To examine whether a group of target data corresponds to the region information 105 in the place name data 101, the CPU 002 performs processing for scanning all the target data by processes performed in step S715 and the subsequent steps.

In step S717, the CPU 002 extracts position information of the target data. In step S718, the CPU 002 determines whether the position information of the target data (data input by the user) is included in the region information 105 in the place name data 101. If the position information is included in the region information 105 (YES in step S718), then in step S719, the CPU 002 examines whether the user has issued an instruction to consider date/time information. If the user has issued the instruction to consider the date/time information (YES in step S719), then in step S721, the CPU 002 acquires date/time information of the target data. In step S720, the CPU 002 acquires effective period 104 of the place name from the place name data 101. In step S722, the CPU 002 determines whether the date/time information of the target data is included in the effective period 104. If the date/time information is included in the effective period 104 (YES in step S722), then in step S723, the CPU 002 adds the target data to the list.

By the processes in steps S709 to S724, described above, data corresponding to the place name input by the user and a period of time during which the place name has been used can be listed. If the target data is an image, for example, images captured in a period of time during which the place name input by the user has been used can be listed.

The list including the place name data 101 corresponding to the place name designated by the user and the list including data corresponding to the place name data 101 are generated. Therefore, in step S714, the CPU 002 displays items in the list including the target data as a result.

If there is a plurality of place name data 101, the target data may be separated for each of the place name data 101 when displayed. Alternatively, an inclusive relationship of the place name data 101 may be examined using the above-mentioned method, and the place name data 101 may be sequentially displayed in descending order of their areas for the inclusive relationship. Alternatively, the place name data 101 may be sequentially displayed in ascending order of their areas, or only data searched for in the place name data 101, which is a minimum region included in a plurality of regions.

A group of place name data (place name data group) 106 will be described below.

FIG. 4 illustrates a place name database 100 and the place name data group 106.

While an inclusive relationship is determined based on the region information 105 in the above-mentioned exemplary embodiment, the place name data group 106 including extended place name data 101 is defined.

Larger units including a certain region, for example, a city, a town, and a village exist, and are also given individual place names or the same place name. For example, “Saitama” 103 includes “Urawa-ku” 101-6, “Chuo-ku” 101-8, “Omiya-ku” 101-7, and “Iwatsuki-ku” 101-9 in FIG. 4. Alternatively, Chiba Prefecture and Chiba City are given the same place name (Chiba).

As illustrated in the place name data 101 in FIG. 3, all the regions are defined in the region information 105. However, in the place name data group 106 illustrated in FIG. 4, respective indexes 102 in the place name data 101-6, 101-7, 101-8, and 101-9 are defined instead of regions for “Saitama”. If the place name data group 106 is defined, the regions are distinguished by the index 102 and are defined as different databases in the place name database 100. The place name data group 106 itself may be hierarchized into ranges such as a country, a prefecture, a city, a town, and a village, and the ranges are searched for in descending order of their areas so that the search by the region information 105 may be speeded up.

During the search by the place name information 103 and the effective period information 104, the search can be performed in similar processing to that for the place name data 101.

During search by the region information 105, after the search by the region information 105 in the place name data 101 ends, the place name data group 106 including the index 102 in the place name data 101 is searched for a place name in a higher hierarchy.

On the other hand, the sum of coordinate rectangles of all the place name data 101 included in the place name data group 106 is obtained, and the place name data 101 are searched in descending order of hierarchies. If the place name data 101 is excluded from the search, subsequent processing may not be performed.

Thus, targets excluded from search need not be examined. Therefore, the examination is performed at higher speed than when the targets excluded from the search are also examined one by one.

The effective period information 104 in the place name data group 106 satisfies effective period information 104 of data represented by all the indexes 102 in the place name data group 106. If there are elements that differ in the effective period information 104, a plurality of place name data groups 106 that differ in the effective period information 104 is generated.

It may be determined depending on the number of the place name data 101 whether the place name data group 106 is used. Both a method for determining an inclusive relationship in the place name data group 106 and a method for determining an inclusive relationship in the region information 105 in the place name data 101 may be simultaneously defined. A large group serving as a collection of a plurality of groups may be presumed.

In the above-mentioned exemplary embodiment, as a unit configured to narrow down a plurality of place names, the place names are narrowed down by adding a date/time defined in “search by imaging date” 318 as date/time information for the place names in addition to the place name input column 314 illustrated in FIG. 11. In this case, when a list including the place name data 101 is generated, a date/time and an effective period are compared with each other, and the place names in which the date/time and the effective period do not correspond to each other are excluded.

In the above-mentioned exemplary embodiment, when a plurality of information such as “Tokyo”, “Ota-ku”, and “Shimomaruko” is input to the place name input column 314 to search for a place name illustrated in FIG. 11, it has become clear that all respective results of search with keys “Tokyo”, “Ota-ku”, and “Shimomaruko” are in an inclusive relationship. In this case, a region corresponding to the smallest one of the place name data satisfying three conditions “Tokyo”, “Ota-ku”, and “Shimomaruko” is selected as a search result.

If there is an error in accuracy of position information in the data, an accurate place name may be unable to be determined. In this case, if the position information represents the sea having no place name, for example, place name data of a region closest to the sea is selected. A message indicating that a place name corresponding to position information designated by the user cannot be found is displayed.

Image data including a place name designated by the user may be searched for based on the place name designated by the user, a position corresponding to the place name designated by the user may be obtained from the found image data, and image data corresponding to the obtained position may be searched for. In this case, the user designates an old place name, for example, and image data corresponding to the designated old place name, e.g., a picture is searched for. Position information attached to the picture searched for (i.e., position information corresponding to the place name designated by the user) may be obtained, and many pictures corresponding to the found position information may be searched for.

In the above-mentioned processing illustrated in FIG. 5, the user selects data, to acquire position information and date/time information corresponding to the data, and search for a place name corresponding to the acquired position information and date/time information. However, the present exemplary embodiment is not limited to this. The user may directly designate a position and a date/time on a display screen, for example, and may search for a place name corresponding to the position information and the date/time information acquired by the designation.

In the processing illustrated in FIG. 5, a place name corresponding to a position and a date/time corresponding to data is output. However, the present exemplary embodiment is not limited to this. A place name and information (e.g., a text) representing an effective period of the place name may be output.

Furthermore, in the processing illustrated in FIG. 6, for a place name input by the user, data corresponding to a position and a period of time corresponding to the place name is searched for. However, the present exemplary embodiment is not limited to this. A position and a period of time corresponding to the place name may be specified, and information (e.g., a text) representing the position and the period of time may be output.

### OTHER EMBODIMENTS

Exemplary embodiments of the present invention can also be realized by a computer of a system or apparatus that reads out and executes computer executable instructions recorded on a storage medium (e.g., computer-readable storage medium) to perform the functions of one or more of the above-described embodiment(s), and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that these exemplary embodiments are not seen to be limiting. The scope of the following claims is to be accorded the broadest interpretation so as to encompass all such modifications and equivalent structures and functions.

This application claims the benefit of Japanese Patent Application No. 2014-078559 filed Apr. 7, 2014, which is hereby incorporated by reference herein in its entirety.

What is claimed is:

1. An information processing apparatus configured to search a place name database for a place name, the place name database including place name data that defines place name information representing a place name, effective period information representing a period during which the place name is effective, and region information representing a region covered by the place name, the information processing apparatus comprising:
an acquisition unit configured to acquire position information and date/time information; and
a search unit configured to search the place name database for at least one piece of place name data including region information including the position information acquired by the acquisition unit and effective period information corresponding to the date/time information acquired by the acquisition unit.

2. The information processing apparatus according to claim 1, wherein, when at least one piece of found place name data includes a plurality of pieces of place name data, an inclusive relationship is determined from among respective region information in the plurality of pieces of place name data.

3. The information processing apparatus according to claim 2, further comprising an output unit configured to output place name information included in place name data found by the search unit.

4. The information processing apparatus according to claim 3, wherein the output unit hierarchically outputs a part of or all of the place name information according to the inclusive relationship.

5. An information processing method for searching a place name database for a place name, the place name database including place name data that defines place name information representing a place name, effective period information representing a period during which the place name is effective, and region information representing a region covered by the place name, the information processing method comprising:
acquiring position information and date/time; and
searching the place name database for at least one piece of place name data including region information including the position information and effective period information corresponding to the date/time information.

6. The information processing method according to claim 5, wherein, when at least one piece of found place name data includes a plurality of pieces of place name data, an inclusive relationship is determined from among respective region information in the plurality of pieces of place name data.

7. The information processing method according to claim 6, further comprising outputting place name information included in place name data found by the search unit.

8. The information processing apparatus according to claim 7, wherein a part of or all of the place name information is hierarchically output according to the inclusive relationship.

9. An information processing apparatus configured to search a place name database for data corresponding to a place name, the place name database including at least one piece of place name data that defines place name information representing a place name, effective period information representing a period during which the place name is effective, and region information representing a region covered by the place name, the information processing apparatus comprising:
a list generation unit configured to search, when the at least one piece of place name data includes a plurality of place name data, the place name information in each of the plurality of pieces of place name data in the place name database for the place name, and generate a list including the place name data corresponding to found place name information; and
a search unit configured to search for data corresponding to the place name by respectively comparing the effective period information and the region information that are defined in the place name data included in the list with date/time information and position information corresponding to the data.

10. The information processing apparatus according to claim 9, wherein, in a case where a plurality of pieces of place name information has been found, if there is a large place name including regions respectively corresponding to the plurality of pieces of the found place name information, the regions, the included number of which is the largest, are determined as minimum region information, and searching for a piece of the place name data corresponding to the minimum region information.

11. The information processing apparatus according to claim 9, further comprising an output unit configured to output the position information found by the search unit.

12. The information processing apparatus according to claim 9, wherein a sum of coordinate rectangles of all place name data included in a place name data group is obtained, the place name data is searched in descending order of hierarchies, and subsequent processing is not performed if the place name data is excluded from the search.

13. The information processing apparatus according to claim 9, wherein, in a case where a plurality of pieces of information is input to a place name input column, if all search results respectively using the information input to the place name input column as keys are in an inclusive relationship, a region corresponding to minimum place name data satisfying all the keys is selected as a search result.

14. The information processing apparatus according to claim 9, wherein, if an accurate place name cannot be determined due to an error occurring in accuracy of the position information corresponding to the data, the place name data having a region closest to the position information is selected, and a message indicating that the place name corresponding to the position information is not found is provided.

15. The information processing apparatus according to claim 9, wherein, based on the place name, image data including the place name is searched, a position corresponding to the place name is obtained from found image data, and image data corresponding to the obtained position is searched for.

16. An information processing method for searching a place name database for data corresponding to a place name, the place name database including at least one piece of place name data that defines place name information representing a place name, effective period information representing a period during which the place name is effective, and region information representing a region covered by the place name, the information processing method comprising:
searching, in a case where the at least one place name data includes a plurality of pieces of place name data, the place name information in each of the plurality of pieces of place name data in the place name database for a place name and generating a list including the place name data corresponding to found place name information; and
searching for the data corresponding to the place name by respectively comparing the effective period information and the region information that are defined in the place name data included in the list with date/time information and position information corresponding to the data.

17. The information processing method according to claim 16, wherein, when at least one piece of found place name data includes a plurality of pieces of place name data, an inclusive relationship is determined from among respective region information in the plurality of pieces of place name data.

18. The information processing method according to claim 17, further comprising outputting place name information included in place name data found by the search unit.

19. The information processing apparatus according to claim 18, wherein a part of or all of the place name information is hierarchically output according to the inclusive relationship.

20. A computer-readable storage medium storing computer executable instructions for causing a computer to perform an information processing method for searching a place name database for a place name, the place name database including place name data that defines place name information representing a place name, effective period information representing a period during which the place name is effective, and region information representing a region covered by the place name, the information processing method comprising:
acquiring position information and date/time; and
searching the place name database for at least one piece of place name data including region information including the position information and effective period information corresponding to the date/time information.

21. A computer-readable storage medium storing computer executable instructions for causing a computer to perform an information processing method for searching a place name database for data corresponding to a place name, the place name database including at least one piece of place name data that defines place name information representing a place name, effective period information representing a period during which the place name is effective, and region information representing a region covered by the place name, the information processing method comprising:
searching, in a case where the at least one place name data includes a plurality of pieces of place name data, the place name information in each of the plurality of pieces of place name data in the place name database for a place name and generating a list including the place name data corresponding to found place name information; and
searching for the data corresponding to the place name by respectively comparing the effective period information and the region information that are defined in the place name data included in the list with date/time information and position information corresponding to the data.
